(19) United States
(12) Patent Application Publication
(10) Pub. No.: US 2008/0040605 A1
(43) Pub. Date: Feb. 14, 2008

(54) Information storage device and method of controlling the same

(75) Inventor: Hironori Motoe, Ome-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/784,280

(22) Filed: Apr. 5, 2007

(30) Foreign Application Priority Data
Apr. 27, 2006 (JP) 2006-123852

(51) Int. Cl. H04L 9/00

(52) U.S. Cl. 713/168

(57) ABSTRACT

According to one embodiment, an information storage device, includes an input unit, a converter converting an input signal from the input unit, a verifying unit verifying a signal obtained by the conversion of the converter and authentication information which is read from a storage unit storing the authentication information, and a canceling unit canceling a password which is set, if the verification is accepted by the verifying unit.

### CROSS-REFERENCE TO RELATED APPLICATIONS

This application is based upon and claims the benefit of priority from Japanese Patent Application No. 2006-123852, filed Apr. 27, 2006, the entire contents of which are incorporated herein by reference.

### BACKGROUND

1. Field

One embodiment of the invention relates to the present invention relates to an external storage device connectable to a computer and, more particularly, to an information storage device comprising a security function and a method of controlling the device.

2. Description of the Related Art

It is disclosed by, for example, as an external storage device which is connectable to a personal computer, etc. and which comprises a security function, a technique equipped with a nonvolatile semiconductor memory and a fingerprint sensor to execute authentication is disclosed in, for example, JP-A No. 2005-128741 (KOKAI).

According to this technique, however, access prohibition cannot be set at the storage device alone. In addition, security using a powerful password function which the storage device has cannot be implemented. Moreover, the above technique does not have a function of canceling security with key input which the storage device has.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary a perspective view showing an information storage device according to an embodiment of the present invention, and a notebook-type computer to which the information storage device is connected;

FIG. 2 is an exemplary a block diagram showing a configuration of an external hard disk drive serving as the information storage device according to the embodiment of the present invention;

FIG. 3 is an exemplary a flowchart showing a method of controlling the information storage device according to the embodiment of the present invention;

FIG. 4 is an exemplary a block diagram showing a configuration of an external hard disk drive serving as an information storage device according to a modified embodiment of the present invention; and

FIG. 5 is an exemplary a block diagram showing a configuration of an external hard disk drive serving as an information storage device according to another modified embodiment of the present invention.

### DETAILED DESCRIPTION

Various embodiments according to the invention will be described hereinafter with reference to the accompanying drawings. In general, according to one embodiment of the invention, an information storage device, comprises: an input unit; a converter converting an input signal from the input unit; a verifying unit verifying a signal obtained by the conversion of the converter and authentication information which is read from a storage unit storing the authentication information; and a canceling unit canceling a password which is set, if the verification is accepted by the verifying unit.

Embodiments of the present invention will be described below with reference to the accompanying drawings.

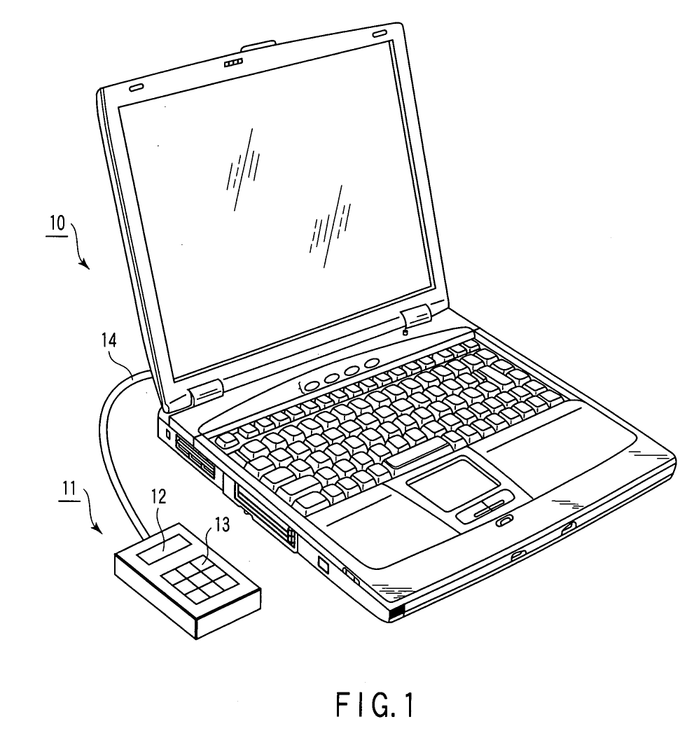

FIG. 1 is a perspective view showing an information storage device according to the embodiment of the present invention, and a notebook-type computer 10 to which the information storage device is connected. The information storage device is implemented as an external hard disk drive 11 which is connected to the notebook-type computer 10 and can be driven by an electric power supplied from the computer 10.

As shown in FIG. 1, the external hard disk drive 11 is connected to the computer 10 by, for example, a USB cable 14 and can be driven with a bus power which is supplied from the computer 10 via the USB cable 14.

The external hard disk drive 11 comprises an LCD 12 serving as a display means and a ten-key 13 serving as an input means. Instead of the ten-key 13, for example, a finger print sensor may be employed.

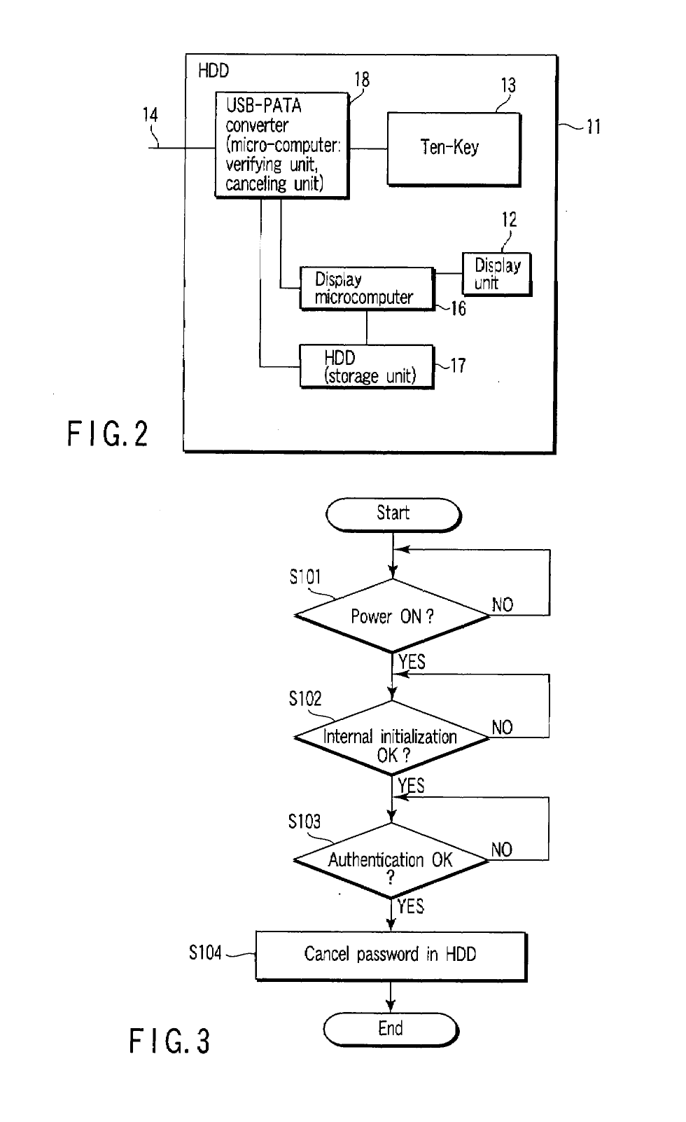

FIG. 2 is a block diagram showing the configuration of the external hard disk drive.

The external hard disk drive 11 comprises a USB-PATA converter (micro-computer: verifying unit, canceling unit) 18 converting data received from the computer 10 via the USB cable 14, the ten-key 13, a HDD (storage unit) 17 which is a nonvolatile memory storing authentication information such as passwords, a display micro-computer 16 verifying the authentication information by the USB-PATA converter 18 stored in the HDD 17 and information obtained by converting the information input from the ten-key 13 by the USB-PATA converter 18 in a predetermined form, discriminating whether authentication is approved and displaying the information on a display unit, and a display unit 12 such as an LCD displaying the information input from the ten-key 13, possibility of the authentication, etc.

Next, a method of controlling the information storage device according to the embodiment of the present invention is described with reference to a flowchart of FIG. 3.

In the present embodiment, processing of canceling a password of the external hard disk drive 11 after connecting the external hard disk drive 11 to the computer 10 is described.

The microcomputer 16 of the external hard disk drive 11 discriminates whether or not a bus power is supplied from the computer 10 via the USB cable 14 (step S101). If the microcomputer 16 discriminates that the power is supplied (power is ON) (YES in step S101), internal initialization is executed by the microcomputer 16. If the processing of internal initialization is completed by the microcomputer 16 (internal initialization OK) (YES in step S102), the USB-PATA converter 18 converts the information input from the ten-key 13 into predetermined information and inputs the predetermined information to the microcomputer 16. The microcomputer 16 verifies the input information and the authentication information such as the password stored in the HDD 17 which is the nonvolatile memory and discriminates whether or not the authentication is OK (step S103). If the verified information items match (i.e. are authenticated; YES in step S103), the microcomputer 16 cancels the password (step S104) and permits access to the external hard disk drive 11.

In addition, access prohibition can be set by using the ten-key 13. For example, if predetermined numbers are input, access prohibition can be set or canceled.

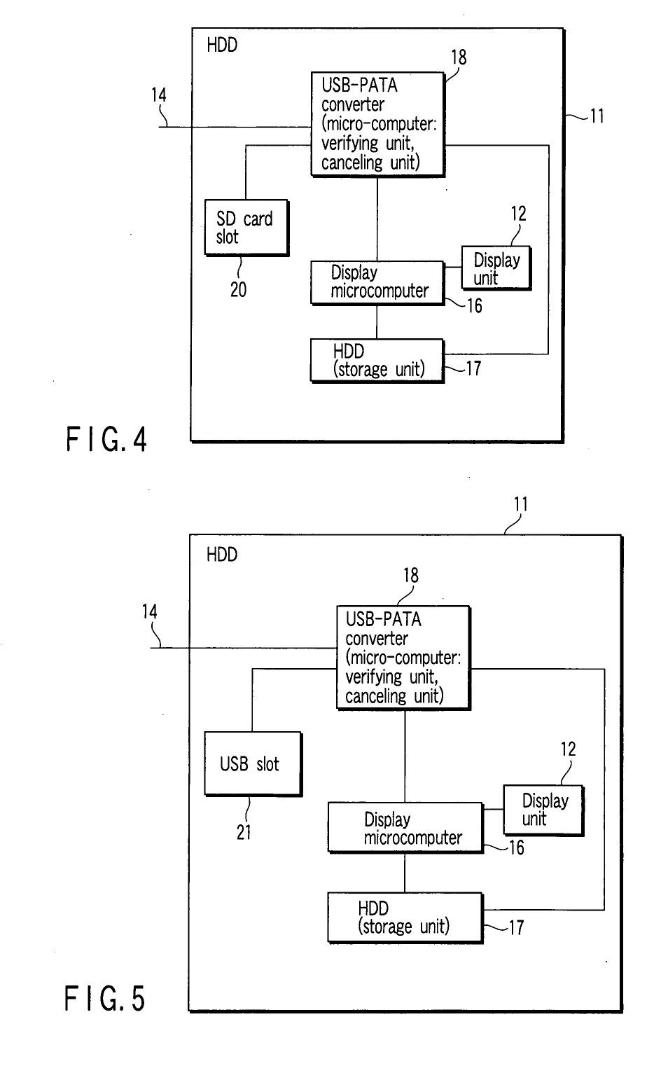

In the above embodiment, the ten-key 13 is used as the input means. However, the authentication information may be input by a fingerprint sensor, by inserting, for example, an SD card which is a flush memory card into an SD card slot as shown in FIG. 4, or by inserting a USB memory into a USB slot as shown in FIG. 5. In these styles, for example, the access prohibition can be set or canceled upon insertion of a flush memory or USB memory in which predetermined information is written.

As described above, according to the embodiments of the present invention, the security using a powerful password function which the storage device has can be implemented and the access prohibition can be set at the storage device alone.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the from of the methods and systems described herein may be made without departing from the spirit of the inventions. The accompanying claims and their equivalents are intended to cover such forms or modifications as would fall within the scope and spirit if the inventions.

What is claimed is:

1. An information storage device, comprising:
an input unit;
a converter converting an input signal from the input unit;
a verifying unit verifying a signal obtained by the conversion of the converter and authentication information which is read from a storage unit storing the authentication information; and
a canceling unit canceling a password which is set, if the verification is accepted by the verifying unit.

2. The device according to claim 1, wherein prohibition of inputting in the device is set by the input from the input unit.

3. The device according to claim 1, further comprising a display unit displaying information which is input from the input unit.

4. The device according to claim 1, wherein the input unit is at least one of a ten-key, an external memory and a fingerprint sensor.

5. The device according to claim 4, wherein the external memory is at least one of a flush card memory and a USB memory.

6. A control method, comprising:
converting an input signal from an input unit;
verifying a signal obtained by the conversion and authentication information which is read from a storage unit storing the authentication information; and
canceling a security function if the verification is accepted.

7. The method according to claim 6, further comprising a display unit displaying information which is input from the input unit.
